(19) United States
(12) Patent Application Publication
(10) Pub. No.: US 2020/0357049 A1
(43) Pub. Date: Nov. 12, 2020

(54) TUNING HYPERPARAMETERS FOR PREDICTING SPENDING BEHAVIORS

(71) Applicant: WEALTH CONDUCTOR LLC, HARTFORD, CT (US)

(72) Inventors: SHERYL O'CONNOR, HARTFORD, CT (US); PHIL LUBINSKI, WHEAT RIDGE, CO (US); THOMAS O'CONNOR, SOUTHINGTON, CT (US)

(21) Appl. No.: 16/858,611

(22) Filed: Apr. 25, 2020

Related U.S. Application Data
(60) Provisional application No. 62/844,732, filed on May 7, 2019.

(51) Int. Cl. G06Q 40/02; G06F 40/30; G06F 16/9535

(52) U.S. Cl. CPC G06Q 40/02; G06F 16/9535; G06F 40/30

(57) ABSTRACT

The subject disclosure relates to systems, methods, and devices that generate a financial behavior predictive model based on the one or more insights. In an aspect, the disclosure includes a system that can curate data from one or more data sources based on relevancy to behavioral data associated with a user financial profile to generate curated data.

### CROSS-REFERENCE TO RELATED APPLICATIONS

This application claims priority to U.S. Provisional Patent Application Ser. No. 62/844,732 titled, “Tuning Hyperparameters for Predicting Spending Behaviors”, filed May 7, 2019. The entirety of the disclosures of the aforementioned applications are considered part of, and is incorporated by reference in, the disclosure of this application.

### BACKGROUND

Often times financial advisors are engaged by clients to organize client finances and project the outcome of savings and investments in preparation for client retirement. As such, financial advisors are often required to predict spending activities of respective clients over long periods of time and up to and through retirement. However, such predictive assumptions are very difficult to determine given that a range of factors can influence a persons' spending decisions on any given day or within any given time range. Accordingly, suggestions as to investment products and appropriate product mix are relevant in light of accuracy of long-term spending estimates. Thus, solutions are needed for spending activity predictions.

### SUMMARY

The following presents a summary to provide a basic understanding of one or more embodiments of the invention. This summary is not intended to identify key or critical elements or delineate any scope of the particular embodiments or any scope of the claims. Its sole purpose is to present concepts in a simplified form as a prelude to the more detailed description that is presented later. In one or more embodiments described herein are systems, devices, apparatuses, computer program products and/or computer-implemented methods that facilitate a determination of a maturity level representing a state of compliance and a risk score representing a vulnerability of a set of protected data in accordance with one or more embodiments described herein.

According to an embodiment, a system is provided. The system comprises one or more processors; and one or more storage devices comprising processor executable instructions that, responsive to execution by the one or more processors, cause the system to perform operations comprising curating data from one or more data sources based on relevancy to behavioral data associated with a user financial profile to generate curated data. Furthermore, the system comprises extracting information from the curated data based, at least in part, on a natural language processing model. Also, the system further comprises analyzing the information to identify one or more insights. In another aspect, the system comprises generating a financial behavior predictive model based on the one or more insights.

### BRIEF DESCRIPTION OF THE DRAWINGS

FIG. 1 illustrates a block diagram of an example, non-limiting representative environment 100, in which automated prediction of financial behavior can occur in accordance with one or more non-limiting embodiments described herein.

FIG. 2 illustrates a flow diagram of an example, non-limiting representative computer-implemented method 200 that can facilitate generation of an automated financial behavior predictive model in accordance with one or more non-limiting embodiments described herein.

FIG. 3 illustrates a flow diagram of an example, non-limiting representative computer-implemented method 300 that can facilitate generation of a set of metrics corresponding to an automated financial behavior predictive model in accordance with one or more non-limiting embodiments described herein.

FIG. 4 illustrates a flow diagram of an example, non-limiting representative computer-implemented method 400 that can facilitate an automated suggestion of a set of products configured to satisfy a set of financial metrics in accordance with one or more non-limiting embodiments described herein.

FIG. 5 illustrates a block diagram of an example, non-limiting operating environment 500 in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section. One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

In an aspect, this disclosure includes systems and methods for generating predictive models that correspond to short and long-term financial behaviors of target clients and/or users. The system can utilize input data from an array of disparate sources to inform the generation of a predictive model that can estimate financial behaviors such as spending habits (e.g., amount spent, carryover expenditures from previous cycles, recurrent expenditures, coupon habits, stores where expenditures take place, user incurring the expense, seasonal spend patterns, expenditure type, etc.). As such, the systems disclosed herein can generate tailored predictive models to estimate financial behaviors such as spending habits over the long-term including into retirement.

In another aspect, systems and methods disclosed herein can generate a suggested group of financial product investments or adjustments to an existing group of financial product investments to match a set of rules related to predicted expenditures throughout a period of time. For instance, systems and methods herein can suggest an adjustment to current basket of stocks, bonds, trusts, investment funds, bank products, options, annuities, retirement income earning investments, college savings investments, cryptocurrency products, commodities, insurance products and other such investments to satisfy threshold spending requirements along one or more periods of time. In general, the systems and methods disclosed herein can utilize machine learning models, predictive analytics technologies and hyper-parameter optimization techniques to accurately generate financial behavior data and financial income generation data associated with a target user profile.

As such, predictive analytics and machine learning algorithms can be employed to curate, extract, transform and/or efficiently execute system modules and data to generate insights about the financial behaviors and income generation needs corresponding to such financial behaviors in an automated and efficacious manner. Furthermore, disclosed are various implementations of platform technologies that provide automated insight generation of financial behaviors and income generation products on a continuous basis. Consider now an example environment in which various aspects as described herein can be employed.

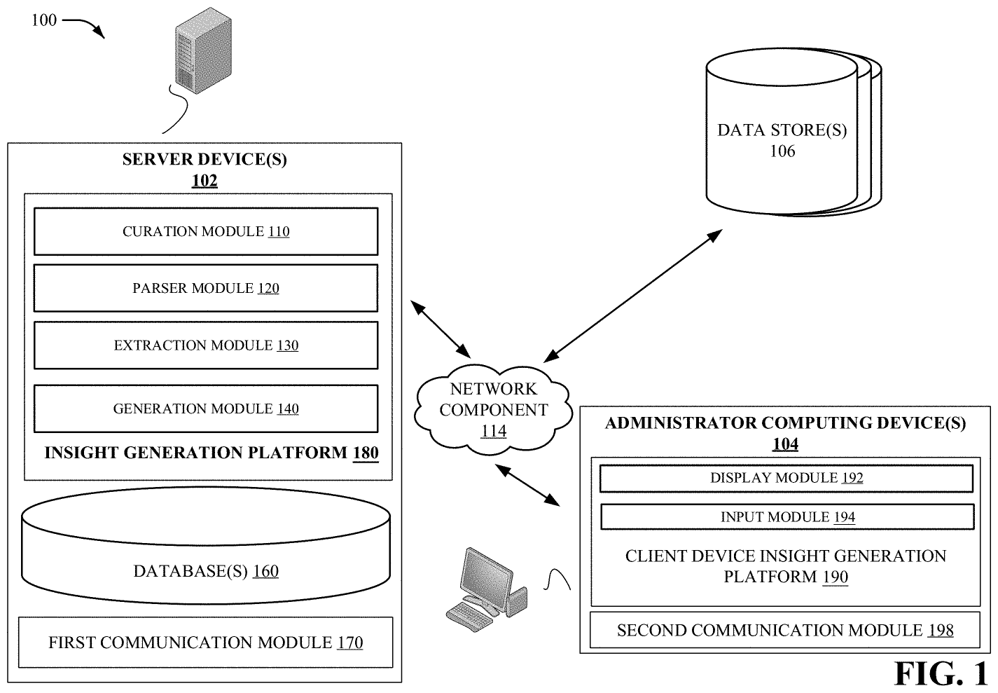

FIG. 1 illustrates a block diagram of an example, non-limiting representative environment 100, in which automated prediction of financial behavior can occur in accordance with one or more non-limiting embodiments described herein.

In an aspect, environment 100 can include an example system that can be used to perform automated prediction of financial behavior of a target user profile in accordance with one or more implementations. Included in environment 100 are server(s) 102, administrator computing device(s) 104, and data store(s) 106 that can collectively coalesce to provide automated determinations of insights to generate a set of predicted financial behaviors such as projected expenditure habits of a user profile over one or more periods of time (e.g., expenditures from age 25 and below, age 25-34, age 45-54, age 55-64, age 65-74, and age 75 and above, etc.). Furthermore, such insights can relate predictions as to the type of expenditures incurred and level of spending incurred during each period of time. For instance, depending on a particular period of time a user profile can be determined to spend varying amounts at different ages on a range items (e.g., food at home, food away from home, housing, clothing, transportation, healthcare, entertainment, pensions, social security, etc.). Given that such financial behavioral insights are determined via an assortment of determinations, the systems disclosed herein sources input data from a rich array of disparate resources (e.g., data store(s) 106).

As such, environment 100 comprises server(s) 102 employs curation module 110 configured to acquire information about data such as various attributes associated with behavioral data. For instance, curation module 110 can curate metadata representing information that results from previous user actions and/or commercial behavior (e.g., sites visited, applications downloaded, etc.) of users associated with a range of devices (e.g., mobile device, tablet, etc.) of a user. Accordingly, environment 100 can draw from a varied array of data to dynamically associate digital behavioral data with values that approximate future spending behaviors based on various predicted stimuli potentials and/or predicted assumed event occurrences over one or more periods of time.

Furthermore, in an aspect, one or more processor(s) of server device(s) 102 can execute generation module 140 to predict spending habits that are inherently more accurate in determining financial behavior responses to various events based on the values associated with the behavioral data that are tuned based on a continuous learning process employed by machine learning models and predictive analytics models in tandem. In another aspect, curation module 110 can source data from a range of data store(s) 106. Furthermore, curation module 110 in connection with parser module 120 can construct and classify data such data based on its intrinsic value as well as behavioral attributes associated with the data as well.

In an aspect, data store(s) 106 can include bank data store(s) (e.g., savings account data, mortgage spend data), credit card data store(s) (e.g., card statement data), general security data store(s) (e.g., general trading account data), retirement saving accounting data store(s), healthcare expenditure data store(s), discretionary expenditure data store(s) and other such data store(s), accounting data stores, distributed data stores, user calendars, user query data store(s), user report data store(s), and other such data stores that represent suitable sources of expenditure data and/or information. Additionally, data store(s) 106 can be configured to store curated data. In an aspect, curation module 110 can analyze data from all such data store(s) 106 into curated data structures that add value to such data.

In an aspect, curation module 110 in connection with parser module 120 and extraction module 130 can generate relationships between various data sets, values, and insights as well as extract important information from such data sets in preparation for generation of predictive behavioral insights. For instance, parser module 120 can receive curated data and analyze such data based on keywords, context information, or other identifying information in order to tag and tokenize such input data (e.g., data string, data array, etc.). Accordingly, parser module 120 can prepare or pre-process the curated data for further processing (e.g., natural language processing) based on carefully segmenting the data (e.g., into linguistic units, numerical units, alpha-numeric units, value-based units, etc.). Also, such parsed curated data can be queried (e.g., using extraction module 130) based on an input query used to extract information from the curated data and such queries can be initiated based on triggering events (e.g., user profile incurring a particular expenditure in real-time, user selecting to use a particular financial product, etc.).

Furthermore, in an aspect, parser module 120 in connection with extraction module 130 can identify subject matter that is accessible or inaccessible to a user profile based on access control rules (e.g., define that a particular user profile or workspace can access curated data) and governance of the extraction of curated data such as by modifying search query input keywords, programmatic access to sections of a data store 106, and other such extraction operations. In an aspect, parser module 120 and extraction module 130 can generate queries that can be used to identify data that efficiently and accurately extract curated data for financial behavioral insight generation by generation module 140. In an aspect, extraction module 130 can extract information from the curated data based, at least in part, on a natural language processing model. However, extraction module 130 in connection with generation module 140 can also extract curated data and generate financial behavioral insights based on an array of algorithms such as natural language generation algorithms, Hidden Markov Model algorithms, probabilistic context free grammars algorithms, and other such algorithms.

In yet another aspect, server device(s) 102 can employ generation module 140 to run various algorithms on curated, parsed and extracted data such as data stored in a curated relational data model database. In an instance, generation module 140 can employ machine learning algorithms to analyze the curated data and/or results generated by various algorithms and generate insights based on such analysis. For instance, generation module 140 can employ machine learning algorithms to analyze expenditure data of user profile and compare such expenditure data to a voluminous set of expenditure data associated with thousands of users to procure insights such as spending patterns of user profiles similar to the target user profile.

As an example, curation module 110 can curate expenditure data (e.g., historical expenditure data) related to food, housing, apparel, healthcare, entertainment, and other expenditures corresponding to the target user profile having an age between 25-34. Furthermore, curation module 110 can access a relational data model database that stores financial behavioral data in accordance with relational models corresponding to logical representations of information. The logical representations of information are generated by assigning one or more behavioral attributes to respective data (e.g., parent data source, child data point, topic of interest, domain of interest, relationships between types of data, etc.).

For instance, a relational database can store curated data related to food expenses to determine how much of total food expenditures are related to outside expenses, grocery expenses, food expenses for children in college, business generating food expenses, and so on. Furthermore, the relationships of curated data at the curated database can be generated using any of a range of diagramming techniques and/or schemas such as Unified Modeling Language, Object-Role Modeling, Extensible Markup Language, Scheme, and other such techniques. Furthermore, the curated data can be parsed and transformed to be categorized within a syntax and/or string of symbols for insight generation. Furthermore, only relevant food expenditures can be selected for data extraction and invalid, corrupted, and/or low-quality data can be left alone rather than extracted for insight generation.

Additionally, generation module 140 can compare the historical behavioral data to sets of behavioral data of respective user accounts that have similar behavioral attributes as the target user account. Furthermore, such similar behavioral attributes can be used to forecast and predict future spending habits of the target user profile based on predictive analytics and machine learning models. Furthermore, generation module 140 can generate predictive insights such as spending amounts, patterns, confidence intervals, and/or spending types of a user over a timeline of various age ranges throughout life. Additionally, the spending predictions can be adjusted based on machine learning hyperparameter tunings as applied to new input data that is recurrently analyzed by the machine learning models. As such, the accuracy of expenditure data insight projections can be adjusted to have increased accuracy and representation of future outcomes based on new input data received by the server device(s) 102.

In another aspect, generation module 140 can utilize actual expenditure data (e.g., data that shows expenditures that have actually occurred, experiential data, etc.) over time to be compared to predicted expenditure data during that time period. As such, generation module 140 can employ adjustments to parameters and hyper-parameters of machine learning models to optimize the predictive function of such models as relates to future expenditures. In an aspect, such hyper-parameter tuning can be an iterative process that captures behavioral data analytics and learnings about previous predicted expenditures and actual expenditures to store as a feedback loop to be utilized by insight generation platform 180 to generate more accurate and informative insights over time and as comparative data set volumes are increased. Furthermore, the feedback loop and systems analytics can apply to algorithms and/or information learned by the personalized analytics system that is subsequently utilized in future data curation, data parsing, data extraction, and future insight generation.

In another aspect, generation module 140 can employ machine learning models to extract insights related to unexpected expenditures or unforeseen expenditures that can impact a set of financial behaviors of a user profile. Furthermore, such unexpected or unforeseen expenditures can be curated with a curation database for establishment of relationships to other data sets unique to a set of similar user profiles. For instance, curation module 110 can curate unexpected expenditures that have a target probability of occurring, such as loss of capacity requiring hired help to assist a user, occurrence of a divorce during retirement that may result in extra spousal benefit fee expenses or income, significant damage to a home, foreclosure expenses related to a home foreclosure of the user, bankruptcy event, fraudulent activity that results in expenses incurred by the user, loss of investment due to poor investment decisions, death of spouse, family emergency, stock market volatility, faster than anticipated asset depletion, illness or disability of the user, home valuations dropping, out of pocket medical or prescription expenses related to a condition or disability of a user, major home repairs or upgrades, high dental expenses.

In yet another aspect, generation module 140 can also automatically suggest a set of financial products comprising any combination of existing products or new products configured to satisfy future expenditure and/or savings requirements. For instance, generation module 140 can suggest an adjustment to an already prepared financial instrument portfolio or generate various permutations of instruments to satisfy or surpass predicted financial expenditure requirements throughout life. For instance, generation module 140 can suggest a weighting of various financial products such as annuities, bonds, retirement income funds, real estate investments, dividend income funds, closed-end funds, certificate of deposits, and other such financial instruments for investment to generate income at various stages throughout a user profiles lifecycle.

As such, generation module 140 can execute expenditure prediction operations and suggest financial product investments to match or satisfy expenditure requirements as per such predictions. In another aspect, server device(s) 102 can also include database(s) 160 and first communication module 170. In an aspect, database(s) 160 can include a database that can be accessed by other modules and can address large amounts of structured and unstructured data. Furthermore, database(s) 160 can represent storage for data generated by the insight generation platform 180 including curated financial behavioral data.

In yet another aspect, first communication module 170 can represent a combination of hardware, software, and/or firmware configured to communicate with external devices and exchange information (e.g., images, addresses, audio, video, commands, messages, predicted expenditure data, suggested financial product information, and so forth). Some implementations of first communication module 170 include one or more protocol stacks associated with a network over which data is exchanged, firmware that drives hardware to generate signals and/or process messages used in maintaining a wireless and/or wired communication session, etc. Alternately or additionally, some implementations of first communication module 170 can include computer networking ports, such as a Transmission Control Protocol (TCP) port, a User Datagram Protocol (UDP) port, a File Transfer Protocol (FTP) port, a Hypertext Transfer Protocol (HTTP) port, an Internet Message Access Protocol (IMAP) port, and so forth. Various implementations of first communication module 170 can include physical communication ports, such as a serial port, a parallel port, a Universal Serial Bus (USB) port, a keyboard port, a display port, an audio port, etc. In various implementations, server device(s) 102 use first communication module 170 to connect with other devices over network component 114 (e.g., cloud), such as computing administrator computing device(s) 104 and/or data store(s) 106.

In another aspect, network component 114 can represent any suitable type of communication network that facilitates a bi-directional link between various computing devices. Accordingly, network component 114 can include multiple interconnected communication networks that comprise a plurality of interconnected elements, such as a wireless local area network (WLAN) with Ethernet access, a wireless telecommunication network interconnected with the Internet, a wireless (Wi-Fi) access point connected to the Internet, an Internet of Things (IoT) network, and so forth. In this example, network component 114 can connect server device(s) 102 with administrator computing device(s) 104.

In an aspect, administrator computing device(s) 104 can includes client device insight generation platform 190 that generally represents user access to some or all of the functionality provided by insight generation platform 180. In some implementations, client device insight generation platform 190 represents a stand-alone client application that interfaces into insight generation platform 180. Alternately or additionally, client input module 194 represents a browser that remotely logs onto a website hosted by server device(s) 102. Further, while client device insight generation platform 190 and insight generation module 180 are illustrated as residing on separate devices, some implementations combine some or all the respective module functionality into a single computing device as further described herein.

In various implementations, administrator computing device(s) 104 uses client device insight generation platform 190 to access cloud-based services provided by server device(s) 102 to obtain behavioral financial insights as further described herein. In this example, client device insight generation platform 190 includes display module 192 to provide user access into features provided by insight generation platform 180, such as inputting a query to the curated behavioral financial data, extracting various financial metrics and/or financial data, providing user feedback, requesting reports, accessing a dashboard and/or corresponding reports, scheduling data curation, scheduling data analysis, suggesting financial products as compared to predicted expenditure data, performing prediction operations, adding databases for data curation, and so forth. In another aspect, administrator computing device(s) 104 can include second communication module 198 to facilitate communications over communication network component 114. As one example, administrator computing device(s) 104 can use second communication module 198 to communicate with insight generation platform 180. Accordingly, similar to that described with respect to first communication module 170, second communication module 198 generally represents any suitable combination of hardware, software, and/or firmware that is configurable to facilitate data exchanges with other devices.

In general, the systems and methods disclosed herein can allow users of administrator computing device(s) 104 (e.g., financial advisors) to predict client user profile expenses and cashflow over a range of periods of time (e.g., through retirement). Furthermore, in an aspect, the systems and methods can include discretionary and non-discretionary expense predictions based on various algorithms, machine learning models, and learnings disclosed herein. As such, the systems and methods disclosed herein can reduce variability of predicted spending expenses and suggested products based on actual financial product performance and other factors (e.g., life event change, change in family obligations, change in income generation, change in financial goals, debt service levels, etc.). Accordingly, more realistic financial behavior estimates can be generated (e.g., based on actual performance and other data sets).

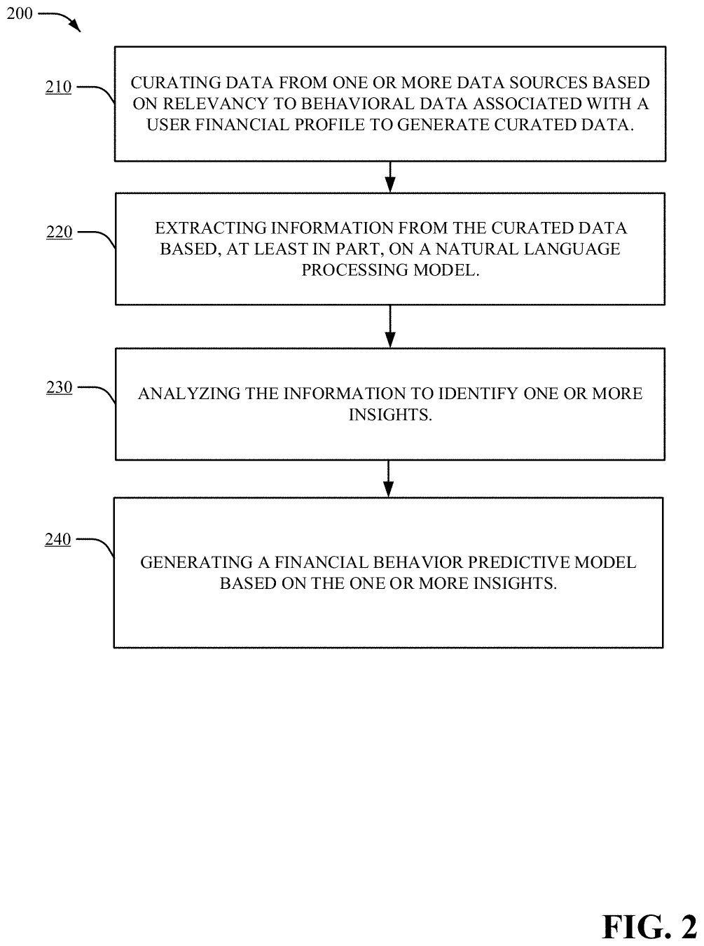

Turning now to FIG. 2, illustrated is a flow diagram of an example, non-limiting representative computer-implemented method 200 that can facilitate generation of an automated financial behavior predictive model in accordance with one or more non-limiting embodiments described herein. In an aspect, one or more of the components described in computer-implemented method 200 can be electrically and/or communicatively coupled to one or more devices. Repetitive description of like elements employed in other embodiments described herein is omitted for sake of brevity.

In some implementations, at reference numeral 210, a system operatively coupled to a processor can curate data from one or more data sources based on relevancy to behavioral data associated with a user financial profile to generate curated data. At reference numeral 220, the system operatively coupled to a processor can extract information from the curated data based, at least in part, on a natural language processing model. At reference numeral 230, the system operatively coupled to a processor can analyze the information to identify one or more insights. At reference numeral 240, the system operatively coupled to a processor can generate a financial behavior predictive model based on the one or more insights.

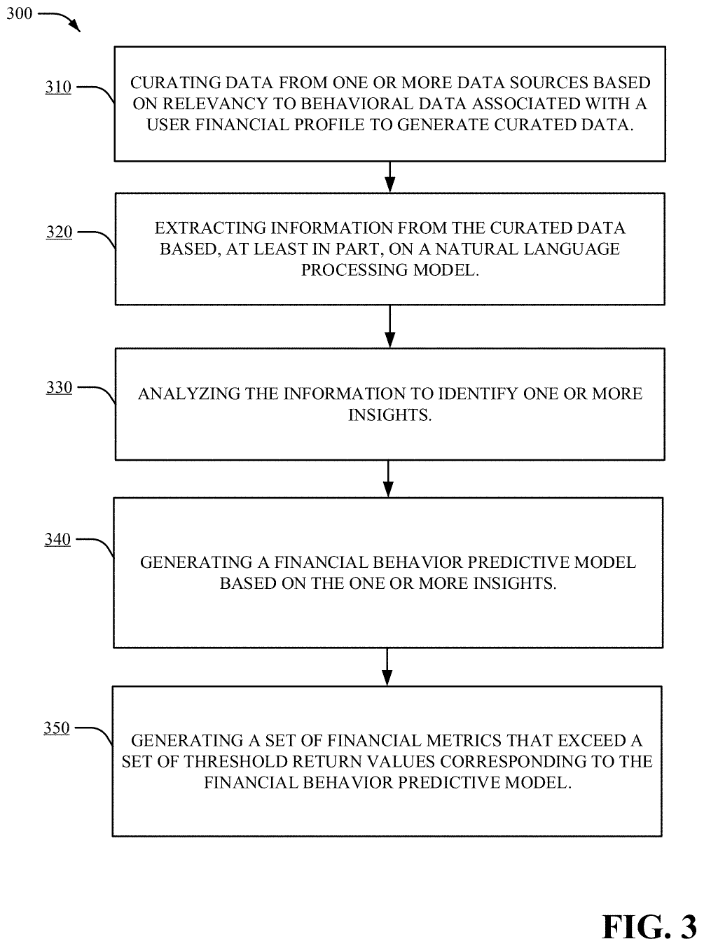

Turning now to FIG. 3 illustrates a flow diagram of an example, non-limiting representative computer-implemented method 300 that can facilitate generation of a set of metrics corresponding to an automated financial behavior predictive model in accordance with one or more non-limiting embodiments described herein. In an aspect, one or more of the components described in computer-implemented method 300 can be electrically and/or communicatively coupled to one or more devices. Repetitive description of like elements employed in other embodiments described herein is omitted for sake of brevity.

In some implementations, at reference numeral 310, a system operatively coupled to a processor can curate data from one or more data sources based on relevancy to behavioral data associated with a user financial profile to generate curated data. At reference numeral 320, the system operatively coupled to a processor can extract information from the curated data based, at least in part, on a natural language processing model. At reference numeral 330, the system operatively coupled to a processor can analyze the information to identify one or more insights. At reference numeral 340, the system operatively coupled to a processor can generate a financial behavior predictive model based on the one or more insights. At reference numeral 350, the system operatively coupled to a processor can generate a set of financial metrics that exceed a set of threshold return values corresponding to the financial behavior predictive model.

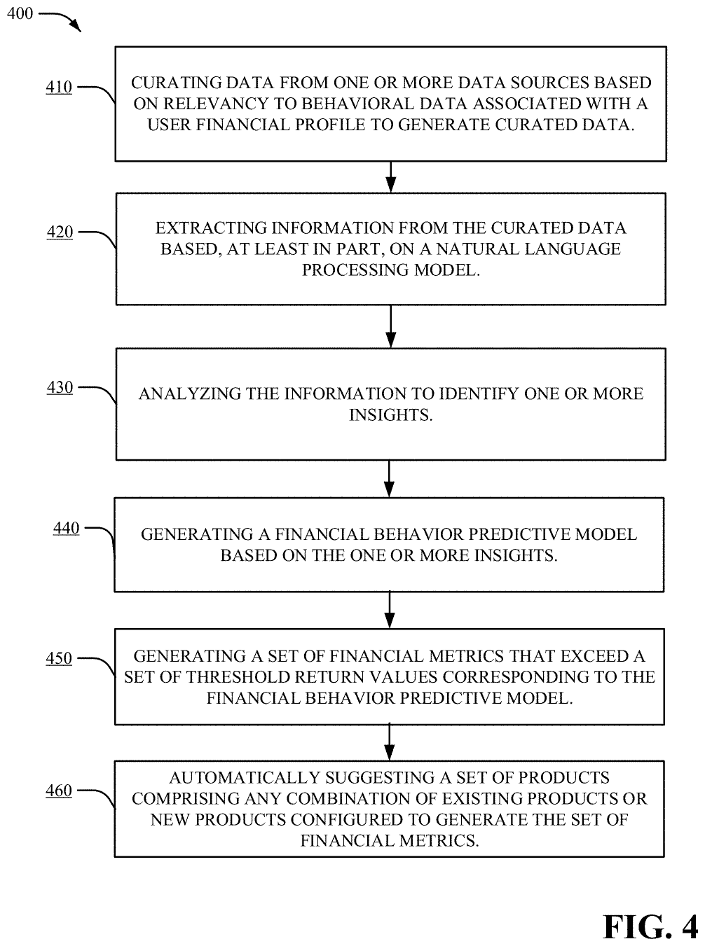

Turning now to FIG. 4 illustrates a flow diagram of an example, non-limiting representative computer-implemented method 400 that can facilitate an automated suggestion of a set of products configured to satisfy a set of financial metrics in accordance with one or more non-limiting embodiments described herein. In an aspect, one or more of the components described in computer-implemented method 400 can be electrically and/or communicatively coupled to one or more devices. Repetitive description of like elements employed in other embodiments described herein is omitted for sake of brevity.

In some implementations, at reference numeral 410, a system operatively coupled to a processor can curate data from one or more data sources based on relevancy to behavioral data associated with a user financial profile to generate curated data. At reference numeral 420, the system operatively coupled to a processor can extract information from the curated data based, at least in part, on a natural language processing model. At reference numeral 430, the system operatively coupled to a processor can analyze the information to identify one or more insights. At reference numeral 440, the system operatively coupled to a processor can generate a financial behavior predictive model based on the one or more insights. At reference numeral 450, the system operatively coupled to a processor can generate a set of financial metrics that exceed a set of threshold return values corresponding to the financial behavior predictive model. At reference numeral 460, the system operatively coupled to a processor can automatically suggest a set of products comprising any combination of existing products or new products configured to generate the set of financial metrics.

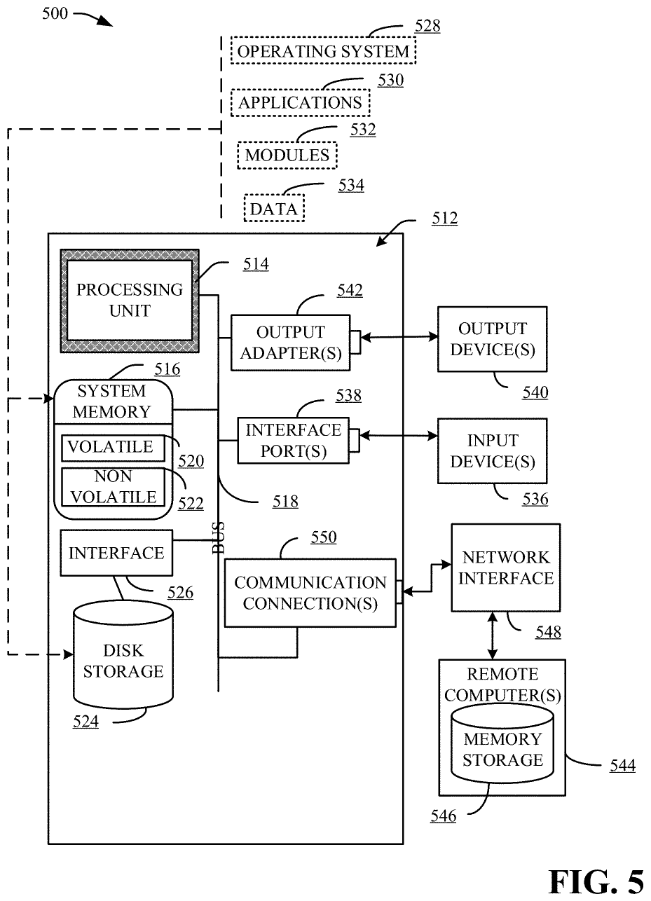

Turning now to FIG. 5 illustrates a block diagram of an example, non-limiting operating environment 500 in which one or more embodiments described herein can be facilitated. Repetitive description of like elements employed in other embodiments described herein is omitted for sake of brevity.

For simplicity of explanation, the computer-implemented methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art can understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

Moreover, because a grouping of data is performed utilizing iterative machine learning and artificial intelligence techniques that facilitate a recurrent and precise grouping of equipment failure data into failure type groups based on similarity comparisons is performed by components executed by a processor established from a combination of electrical and mechanical components and circuitry, a human is unable to replicate or perform the subject data packet configuration and/or the subject communication between processing components, a first grouping component and/or a selection component. Furthermore, the similarity comparisons between grouped and ungrouped data sets are based on comparative determinations that only a computer can perform such as iterative grouping, evaluation, and review of equipment failure data based on unique signatures within the data and use of computer-implemented operations to recognize digital patterns within computer generated data representations to iteratively group data into equipment failure type groups. The generation of digital data based on pattern recognition algorithms and data similarity algorithms as well as storage and retrieval of digitally generated data to and from a memory in accordance with computer generated access patterns cannot be replicated by a human.

In order to provide a context for the various aspects of the disclosed subject matter, FIG. 5 as well as the following discussion is intended to provide a general description of a suitable environment in which the various aspects of the disclosed subject matter can be implemented. FIG. 5 illustrates a block diagram of an example, non-limiting operating environment in which one or more embodiments described herein can be facilitated. With reference to FIG. 5, a suitable operating environment 500 for implementing various aspects of this disclosure can also include a computer 512. The computer 512 can also include a processing unit 514, a system memory 516, and a system bus 518. The system bus 518 couples system components including, but not limited to, the system memory 516 to the processing unit 514. The processing unit 514 can be any of various available processors. Dual microprocessors and other multiprocessor architectures also can be employed as the processing unit 514. The system bus 518 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 516 can also include volatile memory 520 and nonvolatile memory 522. The basic input/output system (BIOS), containing the basic routines to transfer information between elements within the computer 512, such as during start-up, is stored in nonvolatile memory 522. By way of illustration, and not limitation, nonvolatile memory 522 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 520 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 512 can also include removable/non-removable, volatile/non-volatile computer storage media. FIG. 5 illustrates, for example, a disk storage 524. Disk storage 524 can also include, but is not limited to, devices like a magnetic disk drive, floppy disk drive, tape drive, Jaz drive, Zip drive, LS-100 drive, flash memory card, or memory stick. The disk storage 524 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 524 to the system bus 518, a removable or non-removable interface is typically used, such as interface 526. FIG. 5 also depicts software that acts as an intermediary between users and the basic computer resources described in the suitable operating environment 500. Such software can also include, for example, an operating system 528. Operating system 528, which can be stored on disk storage 524, acts to control and allocate resources of the computer 512.

System applications 530 take advantage of the management of resources by operating system 528 through program modules 532 and program data 534, e.g., stored either in system memory 516 or on disk storage 524. It is to be appreciated that this disclosure can be implemented with various operating systems or combinations of operating systems. A user enters commands or information into the computer 512 through input device(s) 536. Input devices 536 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 514 through the system bus 518 via interface port(s) 538. Interface port(s) 538 include, for example, a serial port, a parallel port, a game port, and a universal serial bus (USB). Output device(s) 540 use some of the same type of ports as input device(s) 536. Thus, for example, a USB port can be used to provide input to computer 512, and to output information from computer 512 to an output device 540. Output adapter 1242 is provided to illustrate that there are some output device 540 like monitors, speakers, and printers, among other such output device 540, which require special adapters. The output adapters 542 include, by way of illustration and not limitation, video and sound cards that provide a means of connection between the output device 540 and the system bus 518. It should be noted that other devices and/or systems of devices provide both input and output capabilities such as remote computer(s) 544.

Computer 512 can operate in a networked environment using logical connections to one or more remote computers, such as remote computer(s) 544. The remote computer(s) 544 can be a computer, a server, a router, a network PC, a workstation, a microprocessor based appliance, a peer device or other common network node and the like, and typically can also include many or all of the elements described relative to computer 512. For purposes of brevity, only a memory storage device 546 is illustrated with remote computer(s) 544. Remote computer(s) 544 is logically connected to computer 512 through a network interface 548 and then physically connected via communication connection 550. Network interface 548 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 550 refers to the hardware/software employed to connect the network interface 548 to the system bus 518. While communication connection 550 is shown for illustrative clarity inside computer 512, it can also be external to computer 512. The hardware/software for connection to the network interface 548 can also include, for exemplary purposes only, internal and external technologies such as, modems including regular telephone grade modems, cable modems and DSL modems, ISDN adapters, and Ethernet cards.

The present disclosure may be a system, a method, an apparatus and/or a computer program product at any possible technical detail level of integration. The computer program product can include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system comprising:
one or more processors; and
one or more storage devices comprising processor executable instructions that, responsive to execution by the one or more processors, cause the system to perform operations comprising:
curating data from one or more data sources based on relevancy to behavioral data associated with a user financial profile to generate curated data;
extracting information from the curated data based, at least in part, on a natural language processing model;
analyzing the information to identify one or more insights; and
generating a financial behavior predictive model based on the one or more insights.

2. The system of claim 1, wherein the one or more data sources comprise one or more bank statement data store, credit card expenditure data store, health care expense data store, or other expenditure data store corresponding to the user financial profile.

3. The system of claim 1, the operations further comprising generating a set of financial metrics that exceed a set of threshold return values corresponding to the financial behavior predictive model.

4. The system of claim 3, the operations further comprising automatically suggesting a set of products comprising any combination of existing products or new products configured to generate the set of financial metrics.

5. A system comprising:
a processing system that implements a personalized analytics system comprising:
a curation module to:
identify data to curate by scanning one or more data sources;
curate the data based, at least in part, on identifying relevancy values of behavioral data associated with a user financial profile to generate curated behavioral data attributes and data relationships associated with the data to generate curated data; and
store the curated data in a database based, at least in part, on the behavioral attributes and the data relationships;
a parser module, a query magnifier module, and an insight engine module that work in concert to:
extract information from the curated data based, at least in part, on a natural language processing model; and
identify one or more insights based upon analyzing the information;
a generation module and a product evaluation module that work in concert to generate a financial behavior predictive model based on the one or more insights.
